(19) United States
(12) Patent Application Publication
(10) Pub. No.: US 2024/0286758 A1
(43) Pub. Date: Aug. 29, 2024

(54) MONITORING AN AIRCRAFT FLUID STORAGE TANK ASSEMBLY

(71) Applicant: Airbus Operations Limited, Bristol (GB)

(72) Inventors: Dylan VIGNOLA, Bristol (GB); Adam FALLON, Bristol (GB)

(21) Appl. No.: 18/588,319

(22) Filed: Feb. 27, 2024

(30) Foreign Application Priority Data
Feb. 28, 2023 (GB) 2302945.7

(51) Int. Cl. B64D 45/00; B64F 5/60; G01F 23/80

(52) U.S. Cl. CPC B64D 45/00; B64F 5/60; G01F 23/804

(57) ABSTRACT

A system for monitoring an aircraft fluid storage tank assembly is disclosed including a pressure sensor configured to receive an acoustic signal emitted from a location within the aircraft fluid storage tank assembly in use and a controller. The controller is configured to receive information indicative of the acoustic signal from the pressure sensor and perform a determination process to determine, on the basis of the received acoustic signal, whether to output an indicator of a fault condition of the aircraft fluid storage tank assembly.

### TECHNICAL FIELD

The present invention relates to a computer-implemented method of monitoring an aircraft fluid storage tank assembly, a system for monitoring an aircraft fluid storage tank, a non-transitory computer-readable storage medium and an aircraft.

### BACKGROUND

It may be desirable to monitor aircraft components to ensure that they are operating correctly. In some situations, these components are in difficult to access areas, which may make inspection difficult and time consuming.

### SUMMARY

A first aspect of the present invention provides a system for monitoring an aircraft fluid storage tank assembly, the system comprising: a pressure sensor configured to receive an acoustic signal emitted from a location within the aircraft fluid storage tank assembly in use; and a controller configured to: receive information indicative of the acoustic signal from the pressure sensor; perform a determination process to determine, on the basis of the received acoustic signal, whether to output an indicator of a fault condition of the aircraft fluid storage tank assembly.

The system according to the first aspect may allow the fault condition to be determined without the need to manually inspect the aircraft fluid storage tank assembly (e.g. through visual and/or physical inspection). The fault condition may indicate whether there is a fault with aircraft fluid storage tank assembly, for example a fault with a component of the aircraft fluid storage tank assembly or the presence of a foreign object within the aircraft fluid storage tank assembly, such that inspection is recommended/required.

The acoustic signal may comprise various properties, such as amplitude, frequency, tone, pitch, loudness or duration. The acoustic signal emitted from the aircraft fluid storage tank assembly may be indicative of whether there is a fault with the aircraft fluid storage tank assembly. For example, a component of the aircraft fluid storage tank assembly may emit a sound with a first characteristic when the component is operating correctly, and may make a second, different, sound when the component is operating incorrectly. The sound emitted by the component may also be indicative of a characteristic of the component. For example, the sound emitted by the component may be indicative of an amount of wear on a part of the component and may indicate when service of the aircraft fluid storage tank assembly is required. This may allow the component to be serviced before failing, which may reduce downtime.

The pressure sensor may comprise a high-frequency pressure sensor. The pressure sensor may be configured to measure frequencies which are at least twice the highest frequency of interest. For example, the pressure sensor may be configured to measure frequencies at least twice an operating frequency of a component (such as a pump) of the aircraft storage tank assembly. The pressure sensor may be configured to measure frequencies of around at least 10 kHz, such as around at least 20 kHz, around at least 30 kHz or around at least 40 kHz.

The controller may comprise a memory storing a machine learning model configured to receive the acoustic signal as an input from the pressure sensor and output information indicative of the fault condition of the aircraft fluid storage tank assembly.

The controller may comprise a memory storing a deterministic algorithm configured to receive the acoustic signal as an input and output information indicative of the fault condition of the aircraft fluid storage tank assembly.

The system allows the fault condition of the aircraft fluid storage tank assembly to be determined without the need to manually inspect the aircraft fluid storage tank assembly. The fault condition may be that a component of the aircraft fluid storage tank assembly is not operating correctly and therefore requires inspection. An operator may only need to inspect the component that is determined to have faults, which may speed up maintenance.

The pressure sensor may be configured to be used for at least one further purpose in addition to receiving the acoustic signal from the aircraft fluid storage tank assembly in use. The at least one further purpose may comprise detecting a fuel level within the aircraft fluid storage tank assembly. As the pressure sensor is capable of multiple purposes, this may reduce the total number of sensors within the system, which may reduce the cost and complexity of the system.

The system may comprise a plurality of pressure sensors configured to receive the acoustic signal emitted from the location within the aircraft fluid storage tank assembly in use. The presence of a plurality of pressure sensors to receive the acoustic signal may allow additional properties of the acoustic signal to be determined. For example, the time at which the acoustic signal is received by each of the sensors of the plurality of sensors may allow the location of the source of the acoustic signal to be determined.

The aircraft fluid storage tank assembly may comprise an aircraft fuel tank. The aircraft fuel tank may be located in a wing of an aircraft.

A second aspect of the present invention provides a method of monitoring an aircraft fluid storage tank assembly, the method comprising: receiving an acoustic signal from a location within the aircraft fluid storage tank assembly; performing a determination process to determine, on the basis of the received acoustic signal, whether to output an indicator of a fault condition of the aircraft fluid storage tank assembly.

The method according to the second aspect may allow the fault condition to be determined without the need to manually inspect the aircraft fluid storage tank assembly (e.g. through visual and/or physical inspection). The fault condition may indicate whether there is a fault with the aircraft fluid storage tank assembly, such that inspection is recommended/required. The acoustic signal may be received by a sensor, such as a pressure sensor, which has a purpose in addition to receiving the acoustic signal. This may reduce the need to include additional sensors and may reduce the cost and complexity of the aircraft fluid storage tank assembly.

The acoustic signal may comprise various properties, such as amplitude, frequency, tone, pitch, loudness or duration. The acoustic signal may be indicative of whether there is a fault with the aircraft fluid storage tank assembly, or a component of the aircraft fluid storage tank assembly. For example, the component may emit a sound with a first characteristic when the component is operating correctly, and may make a second, different, sound when the component is operating incorrectly. The sound emitted by the component may also be indicative of a characteristic of the component. For example, the sound emitted by the component may be indicative of an amount of wear on a part of the component and may indicate when service of the aircraft storage tank assembly is required. This may allow the component to be serviced before failing, which may reduce downtime of the aircraft.

The fault condition may comprise that at least one component of the aircraft fluid storage tank assembly is not operating correctly. The at least one component may comprise at least one of: a pump, a valve and a support structure. The acoustic signal emitted by the pump may indicate whether the pump is operating correction. For example, the pump may be known to emit an acoustic signal with a particular frequency when operating correctly, and deviation from this known frequency may indicate a fault with the pump. The valve may emit an acoustic signal indicative of the valve opening and closing. If there is an irregularity in the acoustic signal, this may indicate a fault with the valve. If the support structure comprises a loose fixing, this may generate an acoustic signal. As such, any such acoustic signal may indicate that inspection of the support structure is required. The support structure may be part of the aircraft fluid storage tank assembly or may be part of a wing assembly surrounding the aircraft fluid storage tank assembly.

As mentioned above, the fault condition may comprise the presence of a foreign object (such as debris) in the aircraft fluid storage tank assembly. This may allow an operator to be informed that the foreign object is present in the aircraft fluid tank assembly. The operator may then take action to remove the foreign object to reduce the chance of damage being caused.

The indicator may indicate a property of the foreign object, such as a size of the foreign object. The foreign object may emit an acoustic signal that is dependent on the size of the foreign object. For example, larger foreign objects may emit an acoustic signal with a lower frequency than smaller foreign objects. By determining the size of the foreign object, this may help to determine action that needs to be taken.

The fault condition may comprise whether inspection of the aircraft fluid storage tank assembly is required. This may allow an operator to be provided with a clear indication of whether or not inspection is required. This may also help to predict when maintenance will be required, which may allow maintenance to be scheduled for a time/place which is most convenient to reduce downtime.

The determination process may comprise inputting information indicative of the acoustic signal into a deterministic algorithm, wherein the deterministic algorithm is configured to provide data indicative of the fault condition of the aircraft fluid storage tank assembly; and determining whether to output the indicator on the basis of the provided data.

The determination process may comprise inputting information indicative of the acoustic signal into a machine learning model, wherein the machine learning model is configured to provide data indicative of the fault condition of the aircraft fluid storage tank assembly; and determining whether to output the indicator on the basis of the provided data. The machine learning model may be trained to provide its output based on a set of training data, for example a set of training data labelled with ground truth values in a supervised learning process. For example, a plurality of acoustic signals with known fault conditions may be used to train the machine learning model. In another example, measured data may form a training data set. In some examples, the machine learning model may be updated in real-time based on data obtained by the method.

The machine learning model may comprise a classifier. The classifier may provide a binary output for the fault condition. The classifier may be configured to determine whether the aircraft fluid storage tank assembly requires inspection, based on the acoustic signal. The output of the classifier may be whether or not inspection of the aircraft fluid storage tank assembly is required. The machine learning model may comprise a neural network. Alternatively of additionally, the machine learning model may comprise a support vector machine.

The computer-implemented method may comprise training the machine learning model using training data, wherein the training data comprises information indicative of a plurality of acoustic signals with known fault conditions. Training the machine learning model in this way may enable a more accurate determination of the fault condition associated with a given acoustic signal.

The determination process may comprise comparing at least one characteristic value of the received acoustic signal with at least one predetermined characteristic value. The characteristic value of the received acoustic signal may comprise at least one of: an amplitude, a pitch, a duration and a frequency.

Receiving the acoustic signal may comprise receiving the acoustic signal at a plurality of sensors and the determination process may comprise calculating a location of an origin of the acoustic signal based on a property of the acoustic signal received at each sensor of the plurality of sensors. Determining the location of the component may help to identify a component or objection that is emitting the acoustic signal. The determined location may be compared against known locations of components in the aircraft fluid tank assembly to determine which component the acoustic signal was emitted from. The determined location may also be used to determine whether the component is in the correct position or not, which may indicate a fault with the component.

The property of the acoustic signal may comprise a time of arrival of the acoustic signal at each sensor of the plurality of sensors. If the speed to travel of the acoustic signal is known, or is considered to be constant, and the locations of the plurality of sensors are known, the time of arrival of the acoustic signal can be used to determine the relative distances between the origin of the acoustic signal and each sensor of the plurality of sensors.

The determination process may comprise determining a type of fault condition, and the indicator may indicate the type of fault condition. The determination of the type of the fault condition may be based at least in part on the calculated origin of the acoustic signal.

The computer-implemented method may comprise storing data indicative of at least one of the received acoustic signal and the determined fault condition on a local memory. Storing data indicative of the received acoustic signal and/or the determined fault condition on the local memory may allow the data to be analysed at a later point in time. This may allow the data to be analysed after flight. The data may be stored as a message which is output on a post-flight report. The data may also be used to further improve the accuracy of the method by further defining the predetermined threshold acoustic signal.

The computer-implemented method may comprise transmitting data indicative of at least one of the received acoustic signal and the determined fault condition to a location remote from the aircraft fluid storage tank assembly. Transmitting data indicative of the received acoustic signal and/or the determined fault condition to the remote location may allow the data to be analysed remote from the aircraft. This may allow the data to be analysed in real-time (e.g. during flight) or when required. The data may be stored in a database for use in future operations of the method.

A third aspect of the present invention provides a non-transitory computer-readable storage medium storing instructions that, when executed by an aircraft controller, cause the aircraft controller to carry out the computer-implemented method according to the second aspect of the present invention.

A fourth aspect of the present invention provides an aircraft comprising the system according to the first aspect of the present invention or the non-transitory computer-readable medium according to the third aspect of the present invention.

### BRIEF DESCRIPTION OF THE DRAWINGS

Embodiments of the invention will now be described, by way of example only, with reference to the accompanying drawings, in which:

FIG. 1 shows a schematic view of an aircraft;

FIG. 2 shows a schematic partial cross-sectional view of an aircraft fluid storage tank assembly within a wing of the aircraft of FIG. 1; and

FIG. 3 shows a flow diagram of a method of monitoring an aircraft fluid storage tank assembly.

### DETAILED DESCRIPTION

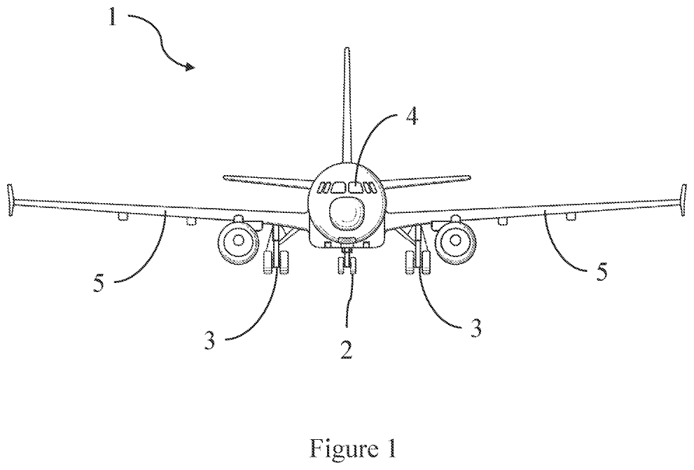

FIG. 1 shows a schematic view of an aircraft 1. The aircraft 1 comprises a nose landing gear 2, two sets of main landing gear 3, a cockpit 4 and two wings 5. The cockpit 4 comprises an interface, e.g. a joystick or dial, to control the position of nose landing gear 2 and/or the main landing gear 3, and a display configured to display information about the aircraft 1 to a flight crew.

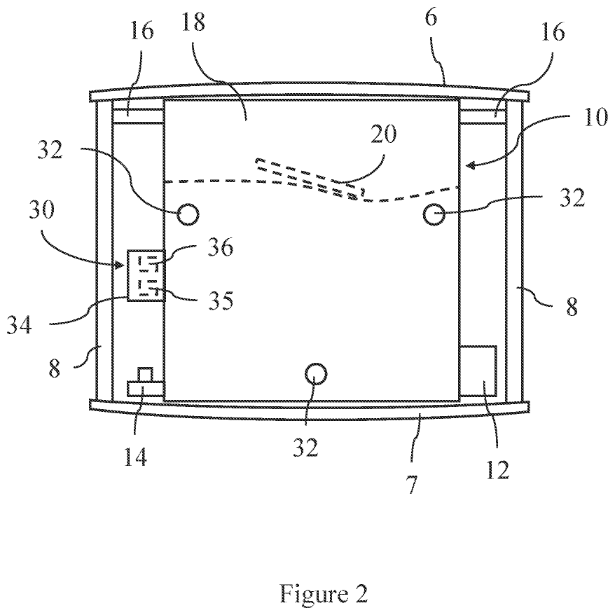

FIG. 2 shows a schematic partial cross-sectional view of an aircraft fluid storage tank assembly 10 within one of the wings 5 of the aircraft 1. The wing 5 comprises an upper surface 6, a lower surface 7 and a pair of spars 8 extending between the upper surface 6 and the lower surface 7, and the aircraft fluid storage tank assembly 10 is located between the upper surface 6, the lower surface 7 and the pair of spars 8.

The aircraft fluid storage tank assembly 10 comprises a fuel tank 18, a pump 12 and a valve 14 in fluid communication with the fuel tank 18, and a support structure 16 to support the fuel tank 18. While in the example of FIG. 2 a separate fuel tank 18 is shown, in some examples the fuel tank 18 is defined by the upper surface 6, the lower surface 7 and forward and rear spars of the wing 5.

In use, the pump 12 and the valve 14 control movement of fuel into and/or out of the fuel tank 18. As the pump 12 and/or the valve 14 operate, they emit an acoustic signal (i.e. a sound). The acoustic signal varies depending on whether the pump 12 and/or the valve 14 are operating correcting. For example, when the pump 12 is operating correctly (e.g. at the correct speed), the pump 12 may emit an acoustic signal with a known frequency. If the pump 12 emits an acoustic signal with a frequency different to the known frequency, this may indicate that the pump 12 not working correctly.

Also shown in FIG. 2 is a system 30 for monitoring the aircraft fluid storage tank assembly 10. The system 30 comprises three pressure sensors 32 and a controller 34. The pressure sensors 32 are high frequency pressure sensors and are capable of detecting signals with frequencies of up to or above 20 kHz. The three pressure sensors 32 are spaced apart from each other around the fuel tank 18 and are configured to receive acoustic signals emitted from the aircraft fluid storage tank assembly 10.

In this example, the pressure sensors 32 are also configured to assist in determining an amount of fuel that is present within the fuel tank 18. As the fuel level changes, a pressure within the fuel tank 18 also changes. As such, measuring the pressure within the fuel tank allows the level of fuel within the fuel tank 18 to be determined. Although three pressure sensors are shown in FIG. 2, in some examples, a greater or fewer number of pressure sensors are used, such as one, two, four or five pressure sensors.

The controller 34 is in communication with the pressure sensors 32. The controller 34 comprises a processor 35 and a memory 36, on which is stored a machine learning model. The machine learning model is configured to receive information from the pressure sensors 32 and to output information indicative of a fault condition of the aircraft fluid storage tank assembly 10.

Machine learning models in the present context may be considered to be the output of a machine learning training process that typically employs a machine learning algorithm that learns from a training dataset. A machine learning model typically comprises both data and procedures that employ the data to process inputs and produce outputs.

The machine learning model may comprise one or more artificial neural network(s) (referred to herein simply as ‘neural network(s)’. A neural network includes a number of interconnected nodes, which may be referred to as artificial neurons, or neurons. The internal state of a neuron (sometimes referred to as an “activation” of the neuron) depends on an input received by the neuron. The value of data applied to each input is weighted, summed, and applied to an “activation function” that sums the weighted inputs in order to determine the output of the neuron. The activation function also has a “bias” that controls the output of the neuron by providing a threshold to the neuron's activation. The output of the neuron then depends on the input, weight, bias, and the activation function. The output of some neurons is connected to the input of other neurons, forming a directed, weighted graph in which vertices (corresponding to neurons) or edges (corresponding to connections) of the graph are associated with weights, respectively. The neurons may be arranged in layers such that information may flow from a given neuron in one layer to one or more neurons in a successive layer of the neural network.

Training of the neural network is important to ensure that a high degree of accuracy is met. Examples of “trainable parameters” of the neural network are the weights, the biases, and the neuron connections that are “learnt”, or in other words, capable of being trained, during a neural network “training” process.

The process of training a neural network includes automatically adjusting the weights that connect the neurons in the neural network, as well as the biases of activation functions controlling the outputs of the neurons. The neural network is presented with a training dataset which includes training input data that has a known classification. In the examples herein, the input training data includes acoustic signals detected by the microphone 18 that have been classified with a fault condition (e.g. indicating whether there is a fault with the mechanical connection such that inspection is required). The training dataset is gathered from observations made during previous operations of the aircraft fluid storage tank assembly 10. The training process automatically adjusts the weights and the biases, such that when presented with input data, the neural network accurately provides the corresponding output. While the training described herein is supervised, in other examples the training may be unsupervised (such that only input training data are provided).

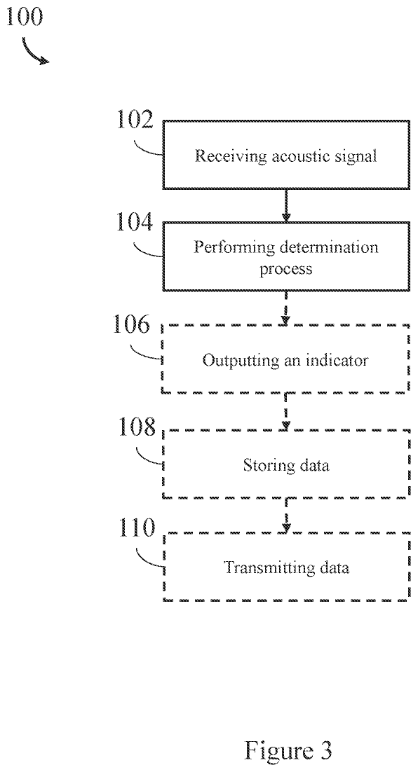

FIG. 3 shows a flow chart of a computer-implemented method 100 of monitoring the aircraft fluid storage tank assembly 10. Steps of the method 100 shown in dashed boxes in FIG. 3 are optional and, in some examples, may be omitted from the method 100. The method 100 may be implemented by the processor 35 of the aircraft controller 34 based on instructions stored on the memory 36 of the controller 34, and comprises: receiving 102 an acoustic signal from a location within the aircraft fluid storage tank assembly 10; and performing 104 a determination process to determine, on the basis of the received acoustic signal, whether to output an indicator of a fault condition of the aircraft fluid storage tank assembly 10.

In the example of FIG. 2, an acoustic signal emitted by the pump 12 is received by the pressure sensors 32. To perform the determination process, information indicative of the acoustic signal, such as the amplitude, frequency, pitch and/or duration of the acoustic signal, is input into the machine learning model stored on the controller 34. The machine learning model then provides data as an output which is indicative of the fault condition of the aircraft fluid storage tank assembly 10, such as whether the pump 12 is working correctly or not.

If the fault condition output by the machine learning algorithm indicates that the pump 12 is not operating correctly, the method 100 comprises outputting 106 an indicator which indicates that the pump 12 is not operating correctly and that inspection of the pump 12 (or the aircraft fluid storage tank assembly 10 as a whole) is recommended. The indicator may be a visual indicator output to the display within the cockpit 4 of the aircraft 1, such that it is visible by the flight crew. The flight crew can then take any appropriate action, such as scheduling maintenance or informing a technician to inspect the pump 12. In some examples, the indicator may be output to the technician and may indicate that maintenance of the aircraft fluid storage tank assembly 10 is required. In some examples, the indicator may comprise a non-visual indicator, such as an audio indicator (such as an alarm sound) in addition to, or as an alternative to, a visual indicator as described above.

The method 100 further comprises storing 108 data indicative of the received acoustic signal and/or the determined fault condition on a local memory, such as the memory 36 of the controller 30, to allow such data to be analysed at a later point in time (such as by the technician while the aircraft 1 is not in operation). The method 100 also comprises transmitting 110 the data indicative of the received acoustic signal and/or the determined fault condition to a location remote from the aircraft fluid storage tank assembly 10 to allow the information to be analysed remote from the aircraft 1. The received acoustic signal and/or the determined fault condition may be analysed at the location remote from the aircraft 1, such as by using an offboard algorithm software/app, to determine whether inspection of the aircraft fluid storage tank assembly 10 is required.

While in the above-described example, the acoustic signal originates from the pump 12, in other examples, the acoustic signal originates from another component of the aircraft fluid storage tank assembly 10, such as the valve 14 and/or the support structure 16. During operation of the valve 14, the valve opens and closes at a known rate and/or time, which causes an acoustic signal with a known frequency to be emitted. If the frequency of the acoustic signal emitted by the valve 14 differs from this known frequency, the fault condition is that the valve 14 is not operating correctly. If the support structure 16 is not secured correctly, for example if a fastener is loose, this causes an acoustic signal to be emitted which is then received by the pressure sensors 32. In such an example, the fault condition is that the support structure 16 is not secured correctly. The method 100 may also be used to monitor other aircraft components near the aircraft fluid storage tank assembly 10, so long as acoustic signals emitted are able to be detected by the pressure sensors 32.

In some examples, the fault condition of the aircraft fluid storage tank assembly 10 is the presence of a foreign object, such as debris 20, within the fuel tank 18. Such debris 20 may have been left in the fuel tank 18 during assembly/maintenance or may have entered the fuel tank during refuelling. The acoustic signal received by the pressure sensors 32 is emitted by the debris 20 itself, and is caused by the debris making contact with the fuel tank 18. As properties of the acoustic signal, such as frequency, differ depending on properties of the debris 20, such as a size of the debris 20, the fault condition also indicates such properties of the debris 20. The indicator output to the display in the cockpit 4 indicates that debris 20 is present within the fuel tank 18 and includes any further properties of the debris 20 determined, such as its size. This output can be used to inform any decision/action taken by the flight crew in response to the fault condition.

In some cases, the acoustic signal is not emitted by the debris 20 itself. Instead, the presence of debris 20 within the fuel tank 18 may affect acoustic signals which are emitted by other components of the aircraft fluid storage tank assembly 10. Accordingly, in some examples, a change in an expected acoustic signal from the aircraft fluid storage tank assembly 10 indicates the presence of debris 20 in the fuel tank 18.

In some cases, the indicator output at step 106 may simply indicate that a fault condition exists in the fuel tank, without indicating the type of the fault condition (e.g. which component(s) is or are at fault and/or that debris is present). In other cases, the indicator may indicate the type of fault conditions i.e. there may be different indicators indicating different fault conditions. The method 100 may comprise determining the type of fault condition. For example, the machine learning model may be trained to provide different output data depending on the type of fault. In one example, the machine learning model comprises multiple neural network systems each trained to recognise different fault conditions, and the method 100 comprises inputting the received acoustic signal into each of the neural network systems, with each of the neural network systems providing output data indicating whether or not the respective fault condition is present. In another example, the machine learning model comprises a neural network system trained to recognise multiple different fault conditions, and to provide output data indicating the type of fault condition present.

Additionally or alternatively, in some examples, performing 104 the determination comprises calculating a location of an origin of the acoustic signal based on a property of the acoustic signal received at the pressure sensors 32. As three pressure sensors 32 are used in the system 10, it is possible to determine the location of the origin of the acoustic signal based on the time at which the acoustic signal is received at each of the pressure sensors 32. By using a difference between the time at which the acoustic signal is received at each of the pressure sensors 32, the location of the origin of the acoustic signal can be triangulated. The location of the origin of the acoustic signal is then used to determine which component of the aircraft fluid storage tank assembly 10 emitted the acoustic signal and/or to determine whether the component is in the correct position. When the component is not in the correct position, the fault condition may be that the component is not in the correct position.

When debris 20 is present in the fuel tank 18, the time at which the acoustic signal is received at each of the pressure sensors 32 may be used to determine the location of the debris 20. This may allow a technician to be informed of the location of the debris, which may speed up removal of the debris 20 during maintenance. Determining the location of the origin of the acoustic signal may also allow the object emitting the acoustic signal to be identified. For example, if the location of the origin of the acoustic signal coincides with a known location of the pump 12, it may be assumed that the pump 12 is emitting the acoustic signal. If the location of origin of the acoustic signal does not correspond to the known location of the pump 12 (or other component of the aircraft fluid storage tank assembly 10), then it may be assumed that the acoustic signal was emitted by debris 20 or by an out of position component.

While in the above-described examples, the step of performing 104 a determination process comprises inputting information indicative of the acoustic signal emitted by the pump 12 into the machine learning model stored on the controller 34, in some examples, performing 104 the determination process comprises comparing a characteristic value of the received acoustic signal against a predetermined characteristic. The predetermined characteristic value is stored on the memory 36 of the controller 34 and is the characteristic value which indicates that the pump 12 is operating correctly. The predetermined characteristic value may be determined through monitoring previous operations of the pump 12. If the characteristic value, such as an amplitude, frequency, pitch and/or duration, of the acoustic signal differs from the predetermined characteristic value, the fault condition is that the pump 12 is not operating correctly and an output is provided to the display in the cockpit 4 to inform the flight crew of the fault condition.

The characteristic value of the acoustic signal may, in some examples, also be used to determine which component of the aircraft fluid storage tank assembly 10 emitted the acoustic signal. For example, an acoustic signal emitted by the pump 12 may have a predetermined characteristic value. If the corresponding characteristic value of the received acoustic signal substantially matches the predetermined characteristic value, it may be assumed that the acoustic signal was emitted by the pump 12. In some other examples, the predetermined characteristic value may correspond to a characteristic value of an acoustic signal which is emitted when a known fault condition occurs. For example, if the received acoustic signal comprises high frequency periodic bursts, this may indicate debris 20 moving around within the fuel tank 18.

Determining the fault condition of the aircraft fluid storage tank assembly 10 as described herein may allow the fault condition to be determined without the need to manually inspect the aircraft fluid storage tank assembly (e.g. through visual and/or physical inspection). The fault condition may indicate whether there is a fault with the aircraft fluid storage tank assembly, such that inspection is recommended/required. The acoustic signal may be received by the pressure sensors, which have a purpose in addition to receiving the acoustic signal. This may reduce the need to include additional sensors, and may reduce the cost and complexity of the aircraft fluid storage tank assembly 10 and/or system 30. For example, the pressure sensors may be configured to assist in determining an amount of fuel that is present within the fuel tank 18.

In some examples, the aircraft fluid storage tank assembly 10 comprises a fluid storage tank other than the fuel tank 18. For example, the fluid storage tank assembly 10 may comprise a water tank or a hydraulic fluid tank. Although the fluid storage tank assembly 10 is located within the wing 5 of the aircraft 1 in the example of FIG. 2, in some examples the fluid storage tank assembly 10 may be located in another part of the aircraft 1 (such as a fuselage). In some examples, the aircraft fluid storage tank assembly 10 is located in another type of aircraft, such as a helicopter.

It is to be noted that the term “or” as used herein is to be interpreted to mean “and/or”, unless expressly stated otherwise.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A system for monitoring an aircraft fluid storage tank assembly, the system comprising:
a pressure sensor configured to receive an acoustic signal emitted from a location within the aircraft fluid storage tank assembly in use; and
a controller configured to:
receive information indicative of the acoustic signal from the pressure sensor; and
perform a determination process to determine, on the basis of the received acoustic signal, whether to output an indicator of a fault condition of the aircraft fluid storage tank assembly.

2. The system according to claim 1, wherein the controller comprises a memory storing a machine learning model configured to receive information indicative of the acoustic signal as an input from the pressure sensor and output information indicative of the fault condition of the aircraft fluid storage tank assembly.

3. The system according to claim 1, wherein the pressure sensor is configured to be used for at least one further purpose in addition to receiving the acoustic signal from the location within the aircraft fluid storage tank assembly in use.

4. The system according to claim 3, wherein the at least one further purpose comprises detecting a fuel level within the aircraft fluid storage tank assembly.

5. The system according to claim 1, comprising a plurality of pressure sensors configured to receive the acoustic signal emitted from the location within the aircraft fluid storage tank assembly in use.

6. A computer-implemented method of monitoring an aircraft fluid storage tank assembly, the method comprising:
receiving an acoustic signal from a location within the aircraft fluid storage tank assembly; and
performing a determination process to determine, on the basis of the received acoustic signal, whether to output an indicator of a fault condition of the aircraft fluid storage tank assembly.

7. The computer-implemented method according to claim 6, wherein the fault condition comprises that at least one component of the aircraft fluid storage tank assembly is not operating correctly.

8. The computer-implemented method according to claim 7, wherein the at least one component comprises at least one of: a pump, a valve and a support structure.

9. The computer-implemented method according to claim 6, wherein the fault condition comprises the presence of a foreign object in the aircraft fluid storage tank assembly.

10. The computer-implemented method according to claim 6, wherein the fault condition comprises whether inspection of the aircraft fluid storage tank assembly is required.

11. The computer-implemented method according to claim 6, wherein the determination process comprises:
inputting information indicative of the acoustic signal into a machine learning model, wherein the machine learning model is configured to provide data indicative of the fault condition of the aircraft fluid storage tank assembly; and
determining whether to output the indicator on the basis of the provided data.

12. The computer-implemented method according to claim 11, comprising training the machine learning model using training data, wherein the training data comprises information indicative of a plurality of acoustic signals with known fault conditions.

13. The computer-implemented method according to claim 6, wherein the determination process comprises comparing at least one characteristic value of the received acoustic signal with at least one predetermined characteristic value.

14. The computer-implemented method according to claim 13, wherein the characteristic value of the received acoustic signal comprises at least one of: an amplitude, a pitch, a duration and a frequency.

15. The computer-implemented method according to claim 6, wherein the determination process comprises determining a type of fault condition, and the indicator indicates the type of fault condition.

16. The computer-implemented method according to claim 6, wherein receiving the acoustic signal comprises receiving the acoustic signal at a plurality of sensors and wherein the determination process comprises calculating a location of an origin of the acoustic signal based on a property of the acoustic signal received at each sensor of the plurality of sensors.

17. The computer-implemented method of claim 16, wherein the determination of the type of the fault condition is based at least in part on the calculated origin of the acoustic signal.

18. The computer-implemented method according to claim 16, wherein the property of the received acoustic signal is a time of arrival of the received acoustic signal at each sensor of the plurality of sensors.

19. The computer-implemented method according to claim 16, comprising storing data indicative of at least one of the received acoustic signal and the determined fault condition on a local memory.

20. The computer-implemented method according to claim 16, comprising transmitting data indicative of at least one of the received acoustic signal and the determined fault condition to a location remote from the aircraft fluid storage tank assembly.

21. A non-transitory computer-readable storage medium storing instructions that, when executed by an aircraft controller, cause the aircraft controller to carry out the computer-implemented method according to claim 6.

22. An aircraft comprising the system according to claim 1.
